(19) United States
(12) Patent Application Publication
(10) Pub. No.: US 2024/0336380 A1
(43) Pub. Date: Oct. 10, 2024

(54) CLOSURE STRIPS OF RESEALABLE ENCLOSURES AND METHODS OF TERMINATING THE CLOSURE STRIPS

(71) Applicant: Illinois Tool Works Inc., Glenview, IL (US)

(72) Inventors: David J. Matthews, Gilman, IL (US); Eric P. Plourde, Frankfort, IL (US)

(73) Assignee: Illinois Tool Works Inc., Glenview, IL (US)

(21) Appl. No.: 18/747,901

(22) Filed: Jun. 19, 2024

Related U.S. Application Data
(62) Division of application No. 17/324,912, filed on May 19, 2021.
(60) Provisional application No. 63/029,874, filed on May 26, 2020.

(51) Int. Cl. B65B 7/02

(52) U.S. Cl. CPC B65B 7/02

(57) ABSTRACT

A method includes obtaining an elongated supply strip formed from an elongated profile body and an elongated flange and modifying portions of the profile body and/or the flange in different locations along a length of the supply strip to define termination ends of closure strips. The supply strip is separated into at least one of the closure strips at the termination ends. The flange in the closure strip is coupled to one or more panels of a resealable enclosure, and the panels are partially sealed to define an opening into the resealable enclosure. The profile body is configured to repeatedly couple with and decouple from itself to close and open the opening in the resealable enclosure. The panels are sealed to each other such that the ends of the closure strip are sealed between the panels.

### CROSS-REFERENCE TO RELATED APPLICATIONS

This application claims priority to U.S. Provisional Application No. 63/029,874, which was filed on 26 May 2020, and the entire disclosure of which is incorporated herein.

### BACKGROUND

### Technical Field

The subject matter described herein relates to closure strips of resealable enclosures, such as self-coupling closures of flexible bags.

### Discussion of Art

Some flexible bags include resealable closure strips that can repeatedly couple with each other and decouple from each other to allow repeated sealing of the bags and opening of the bags. The closure strips may have profiles that engage or intermesh with each to close the bags. These closure strips may be heat sealed or otherwise affixed to webs of thermoplastic material. The web can then be cut and sealed to itself to form a resealable bag.

One problem with some known closure strips is that the thickness of the closure strips can leave gaps at the outer ends of the closure strips when the bags are attempted to be sealed shut. The thickness of the closure strips can prevent the gap between the portions of the web forming the bag from being completely eliminated. As a result, some air may enter into the bag even when the bag is attempted to be sealed shut. This can result in spoilage of product within the sealed bag.

### BRIEF DESCRIPTION

In one embodiment, a method is provided that includes obtaining an elongated supply strip formed from an elongated profile body and an elongated flange and modifying portions of the profile body, the flange, or a combination of the profile body and the flange in multiple different locations along a length of the supply strip. The portions are modified to define termination ends of closure strips. The method also includes separating the supply strip into at least one of the closure strips at the termination ends, coupling the flange in the at least one of the closure strips to one or more panels of a resealable enclosure, and partially sealing the panels of the resealable enclosure to each other to define an opening into the resealable enclosure. The profile body is configured to repeatedly couple with and decouple from itself to close and open the opening in the resealable enclosure. The panels are sealed to each other such that the ends of the closure strip are sealed between the panels.

In one embodiment, another method is provided that includes obtaining a closure strip formed from an elongated profile body and an elongated flange. The profile body is configured to repeatedly couple with and decouple from itself. The method also includes placing the closure strip between panels of a resealable enclosure having an opening and placing seal bars on opposite sides of the panels with the closure strip between the panels. At least one of the seal bars has a recessed groove in a surface that engages at least one of the panels. The method also includes applying heat and pressure to the panels and the closure strip to seal the closure strip to the panels. The closure strip is configured to repeatedly couple with and decouple from itself to close and open an opening in the resealable enclosure.

In one embodiment, another method is provided that includes obtaining an elongated supply strip formed from an elongated profile body and an elongated flange and removing or flattening portions of the profile body, the flange, or a combination of the profile body and the flange in multiple different locations along a length of the supply strip. The portions can be modified to define termination ends of closure strips. The method also includes separating the supply strip into at least one of the closure strips at the termination ends, coupling the flange in the at least one of the closure strips to one or more panels of a resealable enclosure, and partially sealing the panels of the resealable enclosure to each other to define an opening into the resealable enclosure. The profile body is configured to repeatedly couple with and decouple from itself to close and open the opening in the resealable enclosure. The panels are sealed to each other such that the ends of the closure strip are sealed between the panels.

### BRIEF DESCRIPTION OF THE DRAWINGS

The inventive subject matter may be understood from reading the following description of non-limiting embodiments, with reference to the attached drawings, wherein below:

FIG. 1 illustrates one example of a resealable enclosure;

FIG. 2 illustrates the resealable enclosure shown in FIG. 1;

FIG. 3 illustrates part of one example of a closure strip shown in FIG. 2;

FIG. 4 illustrates part of another example of a closure strip shown in FIG. 2;

FIG. 5 illustrates one example of a supply strip from which one or more closure strips can be formed;

FIG. 6 illustrates the closure strip shown in FIG. 5 coupled with the resealable enclosure shown in FIG. 1;

FIG. 7 illustrates another example of a supply strip from which one or more closure strips can be formed;

FIG. 8 illustrates the closure strip shown in FIG. 7 coupled with the resealable enclosure shown in FIG. 1;

FIG. 9 illustrates another example of a supply strip from which one or more closure strips can be formed;

FIG. 10 illustrates the closure strip shown in FIG. 9 coupled with the resealable enclosure shown in FIG. 1;

FIG. 11 illustrates one example of a removed portion of a profile body of a closure strip;

FIG. 12 illustrates the closure strip shown in FIG. 11 coupled with the resealable enclosure shown in FIG. 1;

FIG. 13 illustrates a cross-sectional view of one example of a seal bar assembly that seals a closure strip to panels of the enclosure shown in FIG. 1;

FIG. 14 illustrates a cross-sectional view of the seal bar assembly shown in FIG. 13 sealing the closure strip to the panels;

FIG. 15 illustrates a cross-sectional view of another example of a seal bar assembly that seals the closure strip to the panels of the enclosure shown in FIG. 1;

FIG. 16 illustrates a cross-sectional view of the seal bar assembly shown in FIG. 15 sealing the closure strip to the panels;

FIG. 17 illustrates a flowchart of one example of a method for forming termination ends of closure strips for resealable enclosures;

FIG. 18 illustrates another example of a resealable enclosure having a removable header; and

FIG. 19 illustrates another example of a resealable enclosure having a removable header.

### DETAILED DESCRIPTION

One or more embodiments of the inventive subject matter described herein provide closure strips of resealable enclosures and methods for terminating the closure strips. The closure strips and methods described herein can provide for improved seals at the ends of the closure strips to prevent or reduce entry of air into the enclosures while the closure strips are coupled to themselves to seal the enclosures.

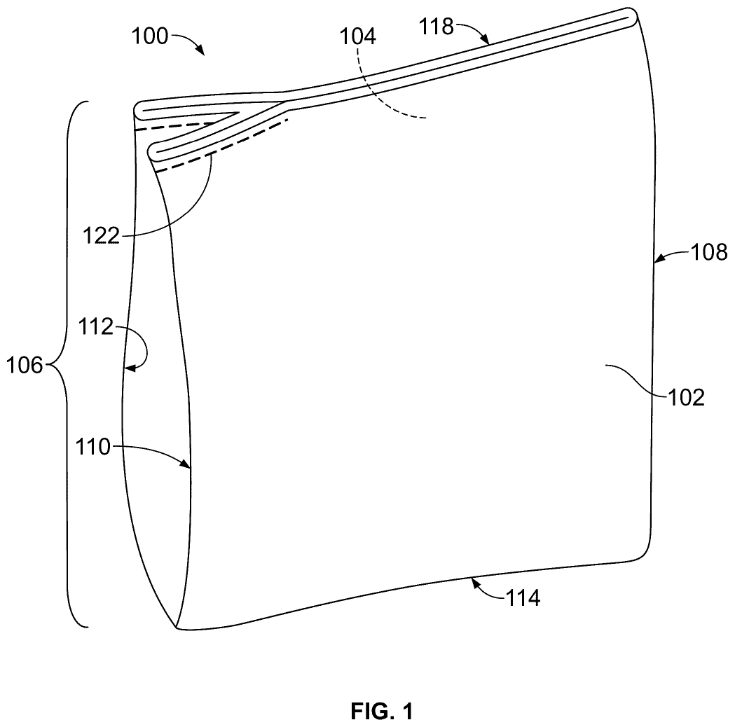

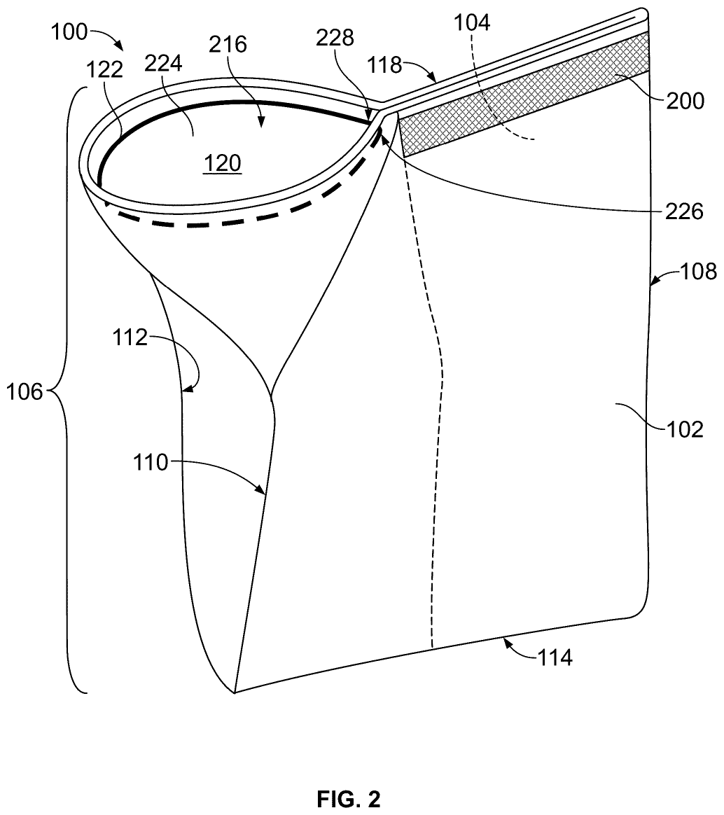

FIGS. 1 and 2 illustrate one example of a resealable enclosure 100. The enclosure 100 is formed from opposite or opposing panels 102, 104 joined with each other along a gusset side 106 and an opposite edge 108. While only the gusset side 106 includes a gusset having gusset edges 110, 112 in FIGS. 1 and 2, optionally, both the edge 108 and the side 106 may include gussets. Alternatively, the enclosure 100 may not have any gusset sides or gusseted sides. The enclosure 100 is shown in a closed state in FIG. 1 and in an open state in FIG. 2. The panels 102, 104 may be formed from a flexible material, such as polymer films or paper, to form a flexible resealable bag.

In one embodiment, the enclosure 100 is formed from a tube of the material forming the panels 102, 104, with the tube cut and the bottom edge of the tube sealed to form a bottom edge 114 that extends from the gusset side 106 to the edge 108. A sealed area 200 (FIG. 2) of the panels 102, 104 represents areas of the interior surfaces of the panels 102, 104 that are sealed to each other to form an opening 216 (shown in FIG. 2) along a top edge 118 of the panels 102, 104. The closure strip 122 extends from one edge of this sealed area 200 to an opposite edge of the sealed area 200. For example, only the bottom side of the flange (that faces away from the profile body) in the closure strip 122 may be coupled with the panels 102, 104 outside of the sealed area 200.

This opening 216 provides access into and exit out of an interior space 120 of the enclosure 100 that is bounded by the panels 102, 104 and the edges 108, 110, 112, 114. As shown in FIG. 2, the opening 216 may form a spout from which the contents inside the enclosure 100 can be poured. The sealed area 200 may be formed by applying an adhesive to the interior surface of the panel 102 and/or the panel 104 and pressing the panels 102, 104 together, by heating the panels 102, 104 within the area of the sealed area 200 and pressing the panels 102, 104 together, or by both applying an adhesive, heating, and pressing the panels 102, 104 together. The sealed area 200 may not be a resealable coupling of the panels 102, 104. For example, pulling the panels 102, 104 apart in the sealed area 200 may rip, tear, or otherwise destroy the seal between the panels 102, 104 that cannot be repaired without applying adhesive and/or heating the panels 102, 104.

The opening 216 extends only partially from the gusset side 106 toward the opposite edge 108 along the top edge 118 without extending across the entirety of the top edge 118 in the illustrated embodiment. Alternatively, the opening 216 may extend over a shorter length of the top edge 118 than what is shown in FIG. 2, may extend over a longer length (but less than all) of the top edge 118 than what is shown in FIG. 2, or may extend over the entire length of the top edge 118.

The enclosure 100 includes an elongated closure strip 122 joined to interior surfaces 224 (shown in FIG. 2) of the panels 102, 104. The elongated closure strip 122 may be joined to the interior surfaces 224 such that the elongated closure strip 122 does not extend outside of the enclosure 100. The elongated closure strip 122 extends from one end 226 to an opposite end 228 (shown in FIG. 2) around the opening 216. The ends 226, 228 of the closure strip 122 may not contact each other. Instead, the ends 226, 228 may be joined to the interior surfaces 224 of the panels 102, 104 such that the ends 226, 228 are spaced apart or otherwise separated from each other.

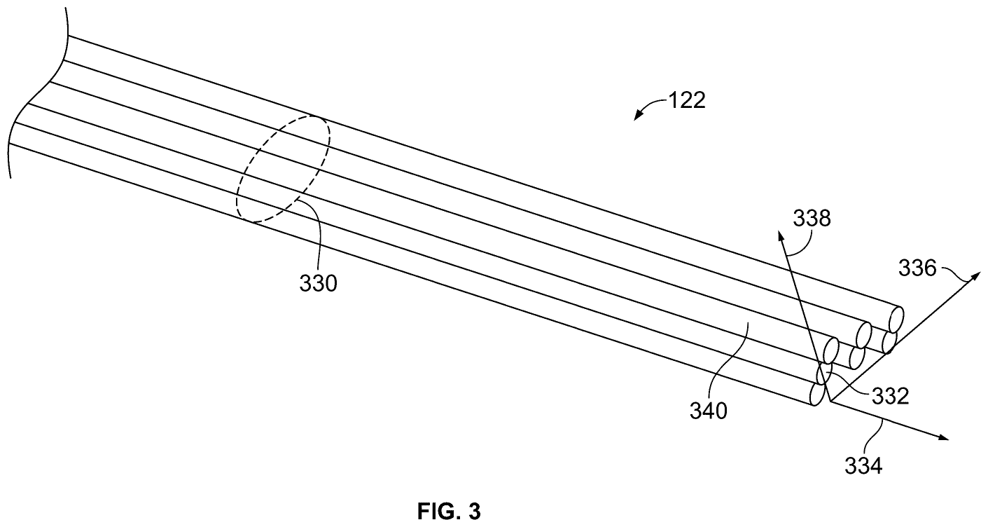

FIG. 3 illustrates part of one example of the closure strip 122 shown in FIG. 2. The closure strip 122 is formed of an elongated profile body 330 that is coupled with an elongated flange 332. The flange 332 may be a flat surface on which the profile body 330 is adhered. The profile body 330 forms a three-dimensional shape that extends along two orthogonal directions 334, 336 along the surface of the flange 332 and that protrudes upward and away from the flange 332 along a third orthogonal direction 338. In the illustrated example, the profile body 330 is formed by several elongated bodies 340 with spaces between the bodies 340. These bodies can have rectangular shapes, square shapes, cylindrical shapes, or the like.

The cylindrical bodies 340 and flange 332 can be formed of flexible materials (e.g., polymers) to allow the cylindrical bodies 340 to be squeezed into the smaller spaces between other cylindrical bodies 340 to hold the closure strip 122 in the folded state. While the profile body 330 is shown as being formed from elongated cylindrical bodies 340, alternatively, the profile body 330 may be formed from intermeshing teeth or other bodies.

The closure strip 122 can be repeatedly secured to itself to close the opening 216 (shown in FIG. 2) and can be repeatedly de-coupled from itself to open the opening 216. The closure strip 122 can be a self-coupling strip in that the closure strip 122 can be folded onto itself such that a first half of the closure strip 122 couples with a second half of the closure strip 122 with the profile body 330 in the first half of the closure strip 122 coupling with the profile body 330 in the second half of the closure strip 122. For example, some of the cylindrical bodies 340 in one portion of the closure strip 122 can be pressed into the spaces between the cylindrical bodies 340 in another portion of the closure strip 122 to fold the closure strip 122 over onto itself and remain in the folded state. The profile body 330 can repeatedly couple and decouple from itself to allow the opening 216 in the enclosure 100 to repeatedly close and open, respectively.

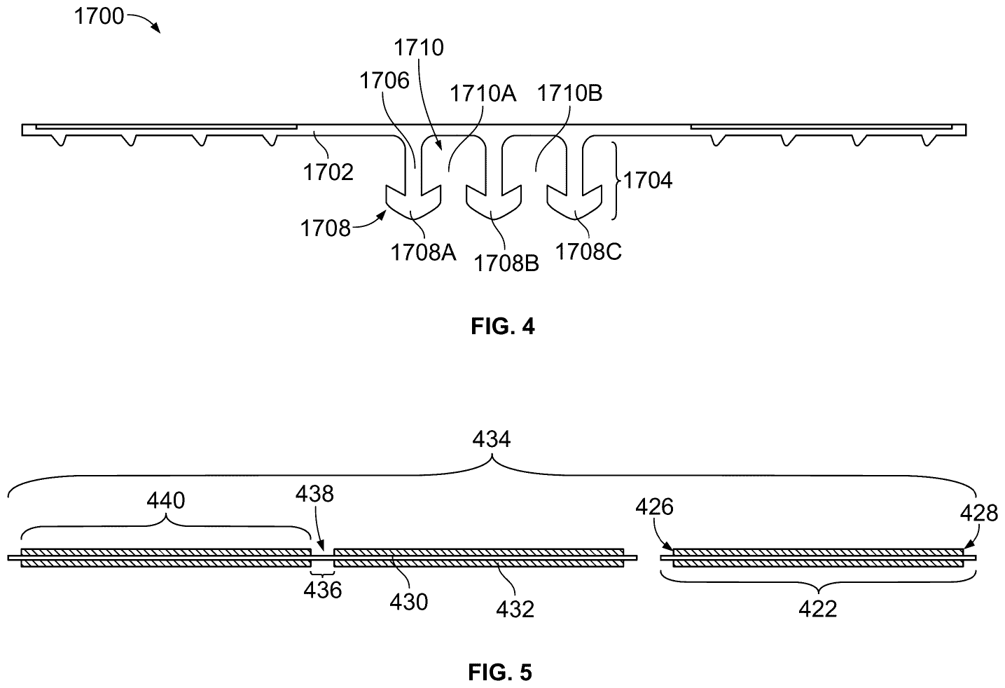

FIG. 4 illustrates a cross-sectional view of another example of a closure strip 1700. The closure strip 1700 is shown in an end view such that a flange 1702 and profile bodies 1704 of the closure strip 1700 are elongated in directions that extend into and out of the page of FIG. 4. The closure strip 1700 can be used in place of the closure strip 122 in embodiments described herein. The flange 1702 may be a flat surface on which the profile bodies 1704 are adhered or coupled. The profile bodies 1704 include elongated stems 1706 that extend from the flange 1702 to fastening heads 1708 (e.g., fastening heads 1708A-C). The stems 1706 are laterally spaced apart from each other by spatial gaps or spaces 1710 (e.g., spaces 1710A, 1710B). The fastening heads 1708 have an angled or arrow shape in the illustrated embodiment, but alternatively may have other shapes. For example, the fastening heads 1708 may have a hook shape or the shape of the letter J, a peg shape, or the like. When the closure strip 1700 is folded back on itself, the fastening heads 1708 may fit into the spaces 1710 between the stems 1706. For example, when the closure strip 1700 is folded back onto itself, the fastening head 1708A may fit into the space 1706A and the fastening head 1708B may fit into the space 1710B. The heads 1708 may engage each other to prevent the closure strip 1700 from easily separating from itself.

The extension of the profile body 330 away from the flange 332 can make it difficult to form a sealed enclosure 100 when the opening 216 is closed. The thickness of the profile body 330 can prevent the opening 216 from being completely closed at or near the ends 226, 228 of the closure strip 122. One or more embodiments of the inventive subject matter provide closure strips and methods for forming or modifying closure strips to ensure that the opening 216 can be sealed shut even at the ends of the closure strip.

FIG. 5 illustrates one example of a supply strip 434 from which one or more closure strips 422 can be formed. For example, the supply strip 434 is longer than the closure strips 422 cut from the supply strip 434. Each of the closure strips 422 cut from the supply strip 434 can represent one of the closure strips shown in FIGS. 1 through 4. The supply strip 434 is formed from a profile body 430 coupled to an elongated flange 432. The profile body 430 can represent the profile body 330 shown in FIG. 3 and the flange 432 can represent the flange 332 shown in FIG. 3.

One or more portions 436 of the flange 432 can be removed from the supply strip 434 while keeping the profile body 430 intact. For example, portions 436 of the flange 432 can be cut away from the profile body 430 along the length of the flange 432 and the length of the profile body 430 without cutting away or removing any part of the profile body 430. This can leave spatial gaps 438 between elongated flange segments 440. The profile body 430 can bridge (e.g., extend through or across) the gaps 438 from one flange segment 440 to another flange segment 440. The flange segments 440 are formed by removing the portions 436 of the flange 432.

The profile body 430 can then be cut in locations within the gaps 438. Cutting the profile body 430 in the gaps 438 forms the closure strips 422 from the supply strip 434, as shown in FIG. 5. The resulting closure strips 422 have the flanges 432 that extend from one end 426 to an opposite end 428, with the profile body 430 in each closure strip 422 protruding beyond the ends 426, 428. For example, the profile body 430 can be longer than the flange segment 440 such that the profile body 430 extends beyond the ends 426, 428. The ends 426, 428 can represent the ends 226, 228 of the closure strip 122 shown in FIG. 2.

In one embodiment, the flange 432 is removed to form the gaps 438 while the profile body 430 continuously extends through the gap, and then the profile body 430 is cut through within the gaps 438. For example, removal of the flange 432 in the gap 438 is completed first and then the profile body 430 is cut within the gap 438. Alternatively, the profile body 430 may be cut through concurrently with removal of the flange 432 to form the gap 438. For example, the profile body 430 and the flange 432 may be cut through and the portions of the flange 432 removed such that the gaps 438 are formed with the profile body 430 extending beyond the ends of the flange segments.

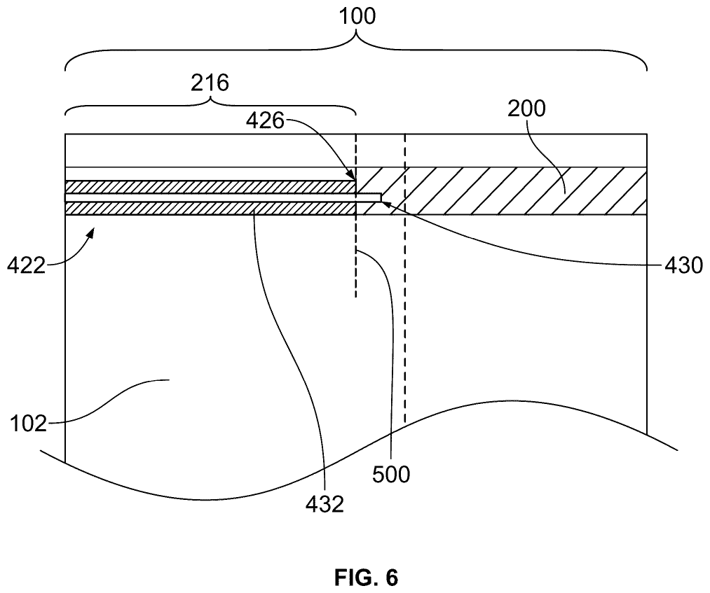

FIG. 6 illustrates the closure strip 422 shown in FIG. 5 coupled with the resealable enclosure 100 shown in FIG. 1. Only the panel 102 of the enclosure 100 is visible in FIG. 6. Additionally, only one half of the closure strip 422 shown in FIG. 5 is visible in FIG. 6. For example, the half of the closure strip 422 that extends from the end 428 to the midpoint between the ends 426, 428 (shown in FIG. 5) is visible in FIG. 6 with the other half of the closure strip 422 located behind the visible half of the closure strip 422. The flange 432 of the closure strip 422 can be sealed to the interior surface of the panel 102 from one edge 500 of the sealed area 200 of the panels 102, 104 to an opposite edge of the sealed area 200 of the panels 102, 104. The opposite edge of the sealed area 200 of the panels 102, 104 is not visible in FIG. 6 but may be directly behind the edge 500 of the sealed area 200. The remainder of the closure strip 422 may have only the bottom side of the flange 432 (that faces away from the profile body 430) coupled with the panels 102, 104 outside of the sealed area 200.

The panels 102, 104 may be sealed to each other to form the opening 216 by sealing the panels 102, 104 from the end 426 of the flange 432 to the opposite end 428 of the same flange 432. As shown in FIG. 6, this causes the sealed area 200 to extend over and include the portions of the profile body 430 that protrude from the flange 432. For example, the protruding portions of the profile body 430 may extend beyond an edge 500 of the sealed area 200 and be sealed between the panels 102, 104 in the sealed area 200. The extension of the profile body 430 into the sealed area 200 between the panels 102, 104 can allow for the opening 216 to be completely closed and sealed by pressing the closure strip 422 onto itself from a mid-point of the closure strip 422 (e.g., between the ends 426, 428) to the ends 426, 428. Because the profile body 430 extends beyond the ends 426, 428 of the flange 432 and the closure strip 422 is sealed to itself to the ends 426, 428 of the flange 432, the closure strip 422 may completely seal the opening 216 closed with no gaps or spaces between the panels 102, 104 and the profile body 430 or flange 432.

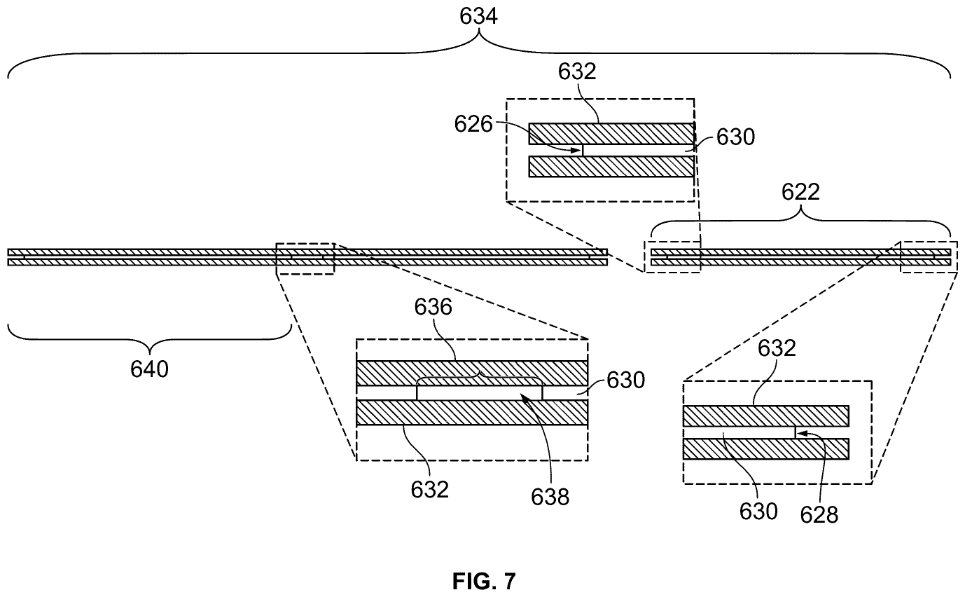

FIG. 7 illustrates another example of a supply strip 634 from which one or more closure strips 622 can be formed. For example, the supply strip 634 is longer than the closure strips 622 cut from the supply strip 634. Each of the closure strips 622 cut from the supply strip 634 can represent one of the closure strips 122, 1700 shown in FIGS. 1 through 4. The supply strip 634 is formed from a profile body 630 coupled to an elongated flange 632. The profile body 630 can represent the profile body shown in FIG. 3 or 4 and the flange 632 can represent the flange shown in FIG. 3 or 4.

One or more portions 636 of the profile body 630 and the flange 632 beneath the removed portion of the profile body 630 can be removed from the supply strip 634 while keeping the flange 632 outside of the portions 636 intact. For example, portions of the profile body 630 (along with the portions of the flange 632 directly beneath and/or coupled with the profile body 630) can be cut away along the length of the profile body 630 without cutting away or removing any other part of the flange 632 (that is not beneath the removed portions of the profile body 630). This can leave spatial gaps 638 between elongated profile body segments 640. The flange 632 can bridge the gaps 638 from one flange segment 640 to another flange segment 640.

The flange 632 can then be cut in locations within the gaps 638. Cutting the flange 632 in the gaps 638 forms the closure strips 622 from the supply strip 634, as shown in FIG. 7. The resulting closure strips 622 have the profile bodies 630 that extend from one end 626 to an opposite end 628, with the flange 632 in each profile body segment 640 protruding beyond the ends 626, 628 of the profile body 630 in that segment 640. For example, the flange 632 can be longer than the profile body segment 640 such that the flange 632 extends beyond the ends 626, 628. The ends 626, 628 of the closure strip 622 can represent the ends 226, 228 of the closure strip 122 shown in FIG. 1.

In one embodiment, the profile body 630 is removed to form the gaps 638 while the flange 632 continuously extends through the gap 638, and then the flange 632 is cut through within the gaps 638. For example, removal of the profile body 630 in the gap 638 is completed first and then the flange 632 is cut within the gap 638. Alternatively, the flange 632 may be cut through concurrently with removal of the profile body 630 to form the gap 638. For example, the profile body 630 and the flange 632 may be cut through and the portions of the profile body 630 removed such that the gaps 638 are formed with the profile body 630 extending beyond the ends of the flange segments.

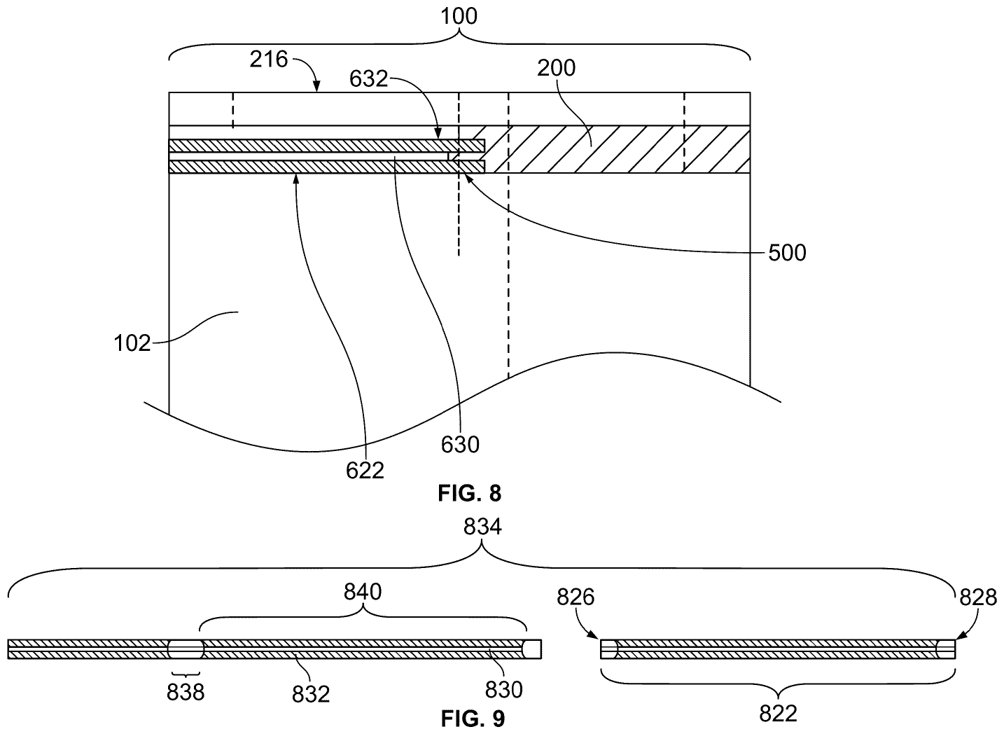

FIG. 8 illustrates the closure strip 622 shown in FIG. 7 coupled with the resealable enclosure 100 shown in FIG. 1. Only the panel 102 of the enclosure 100 is visible in FIG. 8, similar to as described above in connection with FIG. 6. The flange 632 of the closure strip 622 can be sealed to the interior surface of the panel 102 from the edge 500 of the sealed area 200 of the panels 102, 104 to an opposite edge of the sealed area 200 of the panels 102, 104. The opposite edge of the sealed area 200 of the panels 102, 104 is not visible in FIG. 8 but may be directly behind the edge 500 of the sealed area 200.

The panels 102, 104 may be sealed to each other to form the opening 216 by sealing the panels 102, 104 from the end 626 of the profile body 630 to the opposite end 628 of the same profile body 630. As shown in FIG. 8, this causes the sealed area 200 to extend over and include the portions of the flange 632 that protrude from the profile body 630 (due to the flange 632 being longer than the profile body 630). For example, the protruding portions of the flange 632 may be sealed between the panels 102, 104 in the sealed area 200. The remainder of the closure strip 622 may have only the bottom side of the flange 632 (that faces away from the profile body 630) coupled with the panels 102, 104 outside of the sealed area 200. The extension of the flange 632 into the sealed area 200 between the panels 102, 104 can allow for the opening 216 to be completely closed and sealed by pressing the closure strip 622 onto itself from a mid-point of the closure strip 622 to the ends 626, 628. The combination of the profile body 630 and the flange 632 may be sufficiently thick to cause a gap between the panel 102 or 104 and the profile body 630 at the interface with the sealed area 200 of the enclosure 100. Having the profile body 630 extend to, but not into, the sealed area 200 of the enclosure 100 can reduce the thickness of the enclosure 100 at the interface with the sealed area 200 (e.g., relative to the profile body 630 extending into the sealed area 200). This can prevent a gap from being present or can reduce the size of that gap (e.g., relative to the profile body 630 extending into the sealed area 200).

FIG. 9 illustrates another example of a supply strip 834 from which one or more closure strips 822 can be formed. For example, the supply strip 834 is longer than the closure strips 822 cut from the supply strip 834. Each of the closure strips 822 cut from the supply strip 834 can represent one of the closure strips 122 shown in FIGS. 1 and 2. The supply strip 834 is formed from a profile body 830 coupled to an elongated flange 832. The profile body 830 can represent the profile body shown in FIG. 3 or FIG. 4, and the flange 832 can represent the flange shown in FIG. 3 or FIG. 4.

One or more portions 838 of the profile body 830 or of a combination of the profile body 830 and the flange 832 can be flattened to form flatter profile portions of the supply strip 834. These flatter profile portions 838 are disposed between neighboring profile body segments 840. For example, force alone or force and heat may be applied to the portions 838 of the supply strip 834 to reduce a thickness of the profile body 830 and/or the flange 832 (relative to not applying the force). This force may crush the profile body 830 within the portions 838 such that the shape of the profile body 830 has changed and can no longer couple with itself in the flatter profile portions 838.

The profile body 830 and the flange 832 can then be cut in locations within the flatter profile portions 838. Cutting the flange 832 and profile body 830 in the portions 838 forms the closure strip 822 from the supply strip 834, as shown in FIG. 9. The resulting closure strips 822 have the profile bodies 830 and the flange 832 that extend from one end 826 (at the interface with one flatter profile portion 838) to an opposite end 828 (at another interface with another flatter profile portion 838). As shown in FIG. 9, in contrast to the embodiments shown in connection with FIGS. 5 through 8, both the flange 832 and the profile body 830 extend to and are included within both of the flatter profile portions 838, with neither the flange 832 nor the profile body 830 in each closure strip 822 protruding beyond the other (of the profile body 830 or the flange 832). The ends 826, 828 of the closure strip 822 can represent the ends 226, 228 of the closure strip 122 shown in FIG. 1.

The flattened profile body 830 and the flange 832 are cut through in the flattened portion 838 to separate the closure strips 822 from each other. Each of these closure strips 822 can represent the closure strip 122, 1700 shown in FIGS. 1 through 4. As shown in FIG. 9, the closure strip 822 extends from one flattened portion 838 to another flattened portion 838, with the profile body 830 between the flattened portions 838 not being flattened.

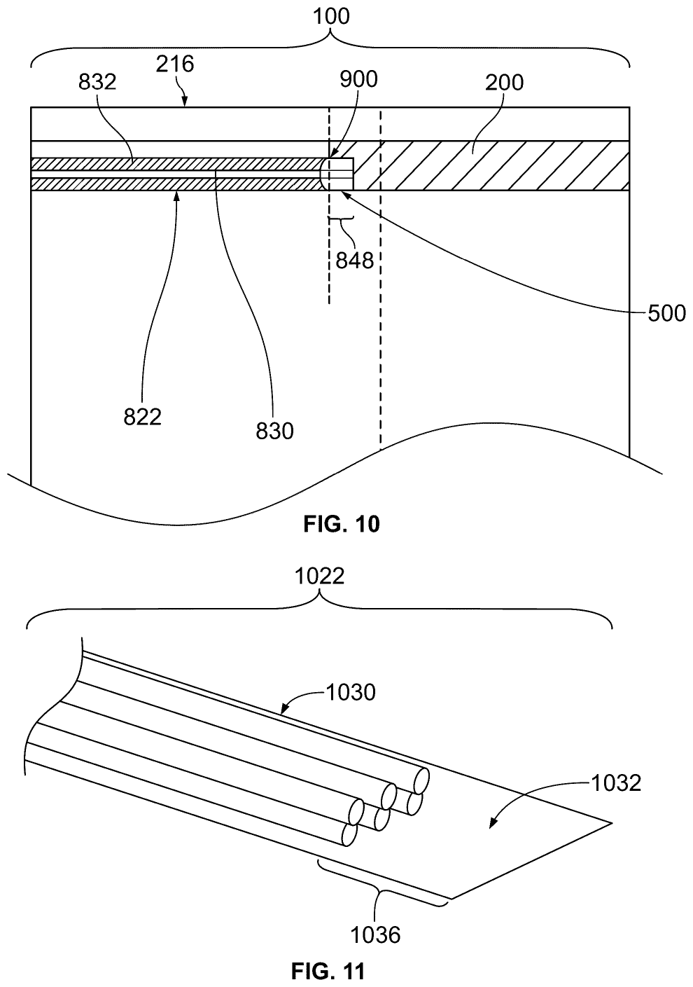

FIG. 10 illustrates the closure strip 822 shown in FIG. 9 coupled with the resealable enclosure 100 shown in FIG. 1. Only the panel 102 of the enclosure 100 is visible in FIG. 10, similar to as described above in connection with FIGS. 6 and 8. The flange 832 of the closure strip 822 can be sealed to the interior surface of the panel 102 from the edge 500 of the sealed area 200 of the panels 102, 104 to an opposite edge of the sealed area 200 of the panels 102, 104. The opposite edge of the sealed area 200 of the panels 102, 104 is not visible in FIG. 10 but may be directly behind the edge 500 of the sealed area 200.

The panels 102, 104 may be sealed to each other to form the opening 216 by sealing the panels 102, 104 from an edge 900 of the flattened portion 848 to the edge of the other flattened portion 848 in the same closure strip 822. As shown in FIG. 10, this causes the sealed area 200 to extend over and include the flattened portions 848. For example, the flattened portions 848 may be sealed between the panels 102, 104 in the sealed area 200, with the remainder of the closure strip 822 having only the bottom side of the flange 832 (that faces away from the profile body 830) coupled with the panels 102, 104 outside of the sealed area 200.

The extension of the flattened portions 848 into the sealed area 200 between the panels 102, 104 can allow for the opening 216 to be completely closed and sealed by pressing the closure strip 822 onto itself from a mid-point of the closure strip 822 to the ends 826, 828. The combination of the profile body 830 and the flange 832 may be sufficiently thick to cause a gap between the panel 102 or 104 and the profile body 830 at the interface with the sealed area 200 of the enclosure 100. The flattened portions 848 reduce the thickness of the enclosure 100 at the interface with the sealed area 200 (e.g., relative to the closure strip 822 not having the flattened portions 848). This can prevent a gap from being present or can reduce the size of that gap (e.g., relative to the closure strip 822 not having the flattened portions 848).

As described above in connection with FIG. 7, the profile body 630 can be removed and the portion of the flange 632 beneath and/or coupled with the removed portion of the profile body 630 can be removed from the closure strip 622 to create the gaps formed by the removed portions 636. Alternatively, only the profile body 630 and not the flange 632 can be removed in the removed portions 636. FIG. 11 illustrates one example of a removed portion 1036 of a profile body 1030 of a closure strip 1022. The closure strip 1022 can represent the closure strip 122 shown in FIGS. 1 and 2, the profile body 1030 can represent the profile body shown in FIG. 3 or FIG. 4, and a flange 1032 to which the profile body 1030 is coupled can represent the flange shown in FIG. 3 or FIG. 4. Instead of removing both the profile body 1030 and the flange 1032 in certain areas to create the removed portions 636 shown in FIG. 7, only a portion 1036 of the profile body 1030 may be removed while the flange 1032 beneath the removed portion 1036 of the profile body 1030 remains, as shown in FIG. 11. The removed portions 1036 of the closure strip 1022 would then have the profile body 1030 removed but the flange 1032 still present.

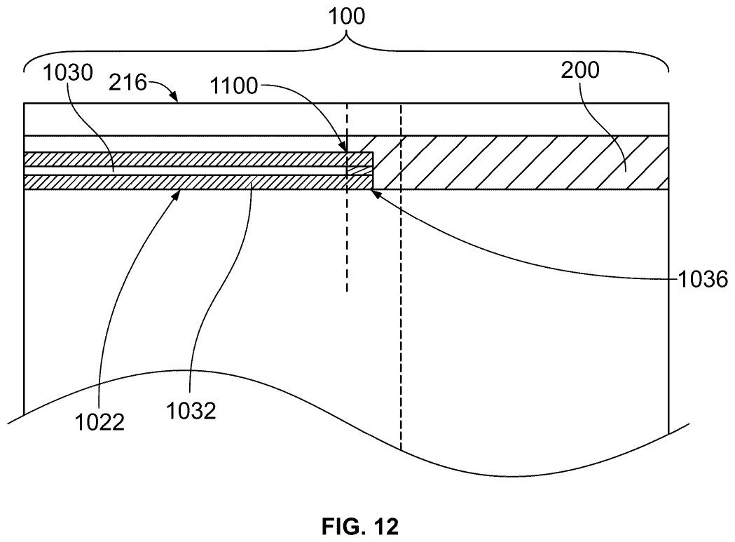

FIG. 12 illustrates the closure strip 1022 shown in FIG. 11 coupled with the resealable enclosure 100 shown in FIG. 1. Only the panel 102 of the enclosure 100 is visible in FIG. 12, similar to as described above in connection with FIGS. 6, 8, and 10. The flange 1032 of the closure strip 1022 can be sealed to the interior surface of the panel 102 from the edge 500 of the sealed area 200 of the panels 102, 104 to an opposite edge of the sealed area 200 of the panels 102, 104. The opposite edge of the sealed area 200 of the panels 102, 104 is not visible in FIG. 12 but may be directly behind the edge 500 of the sealed area 200.

The panels 102, 104 may be sealed to each other to form the opening 216 by sealing the panels 102, 104 from an edge 1100 of the portion 1036 (where only the profile body 1030 is removed from the closure strip 1022) to the edge of the other portion 1036 in the same closure strip 1022. As shown in FIG. 12, this causes the sealed area 200 to extend over the portions of the flange 1032 that laterally project from where the profile body 1030 was located in the portion 1036 and to extend over the flange 1032 that remains beneath where the profile body 1030 was removed.

The extension of the flange 1032 into the sealed area 200 between the panels 102, 104 can allow for the opening 216 to be completely closed and sealed by pressing the closure strip 1022 onto itself from a mid-point of the closure strip 1022 to the ends of the closure strip 1022. The combination of the profile body 1030 and the flange 1032 may be sufficiently thick to cause a gap between the panel 102 or 104 and the profile body 1030 at the interface with the sealed area 200 of the enclosure 100. The portions 1036 where the profile body 1030 was removed reduce the thickness of the enclosure 100 at an interface 1100 with the sealed area 200 (e.g., relative to the closure strip 1022 not having the removed portions 1036). This can prevent a gap from being present or can reduce the size of that gap.

The panels 102, 104 may be sealed to the flanges of the closure strips described herein by placing the closure strip between the panels 102, 104, placing the panels 102, 104 with the closure strip between opposing seal bars, and applying heat and/or pressure via the seal bars to the panels 102, 104 and the closure strip. This heat and/or pressure can melt, bond, or otherwise seal the flange of the closure strip to the panel 102 and/or 104. The seal bars tend to have flat surfaces that engage the panels 102, 104. In one embodiment of the inventive subject matter described herein, however, the seal bars may have grooved recesses that receive the portions of the panels 102, 104 that engage the closure strip. These grooved recesses can avoid crushing or flattening the profile bodies of the closure strips while providing a seal between ends of the closure strips and the panels to seal gaps between the closure strips and the panels.

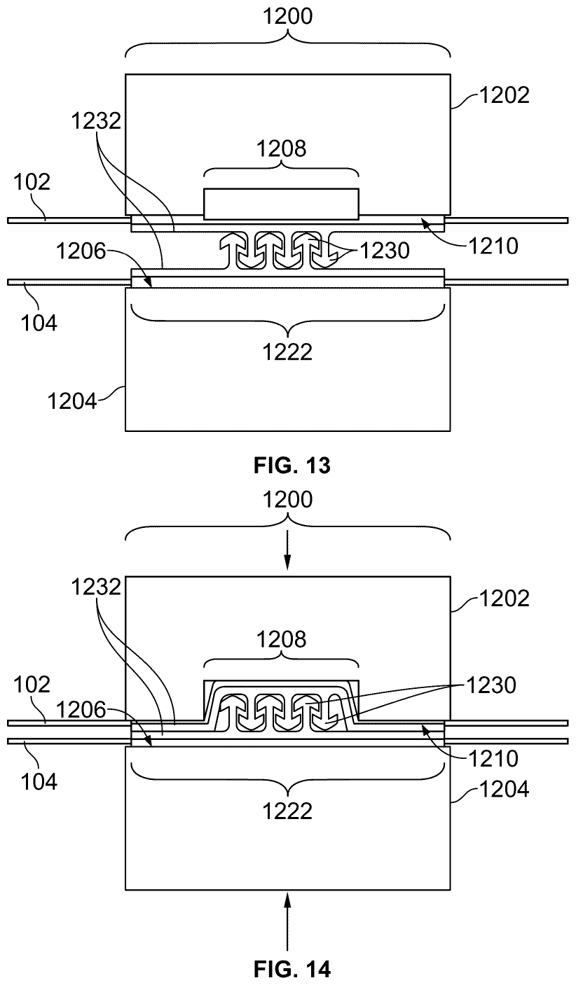

FIG. 13 illustrates a cross-sectional view of one example of a seal bar assembly 1200 that seals a closure strip 1222 to the panels 102, 104 of the enclosure 100 shown in FIG. 1. The seal bar assembly 1200 includes seal bars 1202, 1204. The closure strip 1222 is placed between the panels 102, 104, and the seal bars 1202, 1204 are positioned on opposite sides of the panels 102, 104. As shown, one of the seal bars 1204 has a flat surface 1206 that engages the panel 104 while the other seal bar 1202 has a recessed groove 1208 extending into a surface 1210 that engages the panel 102. As shown, the closure strip 1222 can include both a profile body 1230 and a laterally protruding flange 1232. The closure strip 1222, profile body 1230, and flange 1232 can represent the closure strip 122, profile body 330, and flange 332 described above. No part of the profile body 1230 and/or flange 1232 may be removed from the closure strip 1222, in contrast to the embodiments shown and described in connection with FIGS. 5 through 8 and FIGS. 11 and 12.

FIG. 14 illustrates a cross-sectional view of the seal bar assembly 1200 shown in FIG. 13 sealing the closure strip 1222 to the panels 102, 104. As shown, the seal bars 1202, 1204 may be brought closer together to compress the flange 1232 between the panels 102, 104. The seal bars 1202, 1204 may be heated to melt or otherwise bond the panels 102, 104 with the flange 1232. As shown, the profile body 1230 is received into the groove 1208 in the seal bar 1202 so that the flanges 1232 outside of the profile body 1230 are pressed against each other and the panels 102, 104 between the seal bars 1202, 1204. This groove 1208 prevents the profile body 1230 from being crushed or flattened, while forming a seal between the flanges 1232 and the panels 102, 104 around the profile body 1230. This can reduce or eliminate gaps between the closure strip 1222 and the panels 102, 104.

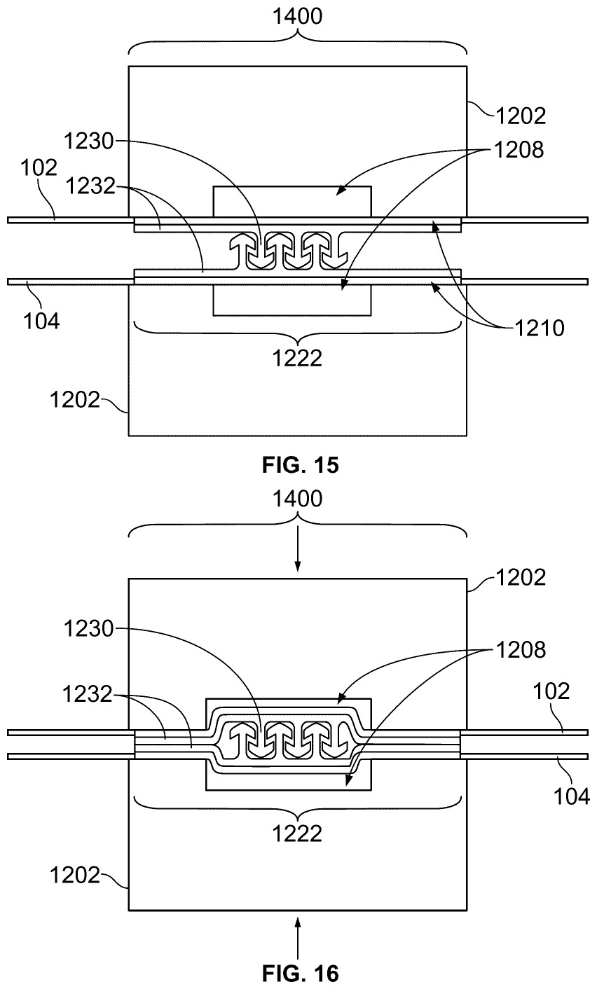

FIG. 15 illustrates a cross-sectional view of another example of a seal bar assembly 1400 that seals the closure strip 1222 to the panels 102, 104 of the enclosure 100 shown in FIG. 1. The seal bar assembly 1400 includes two of the seal bars 1202. The closure strip 1222 is placed between the panels 102, 104, and the seal bars 1202 are positioned on opposite sides of the panels 102, 104. As shown, each of the seal bars 1202 has the recessed groove 1208 extending into the surface 1210 that engages the panel 1202.

FIG. 16 illustrates a cross-sectional view of the seal bar assembly 1400 shown in FIG. 15 sealing the closure strip 1222 to the panels 102, 104. As shown, the seal bars 1202 may be brought closer together to compress the flange 1232 between the panels 102, 104. The seal bars 1202 may be heated to melt or otherwise bond the panels 102, 104 with the flange 1232. As shown, the profile body 1230 is received into the grooves 1208 in the seal bars 1202 so that the flanges 1232 outside of the profile body 1230 are pressed against each other and the panels 102, 104 between the seal bars 1202, 1204. This grooves 1208 prevent the profile body 1230 from being crushed or flattened, while forming a seal between the flanges 1232 and the panels 102, 104 around the profile body 1230. This can reduce or eliminate gaps between the closure strip 1222 and the panels 102, 104.

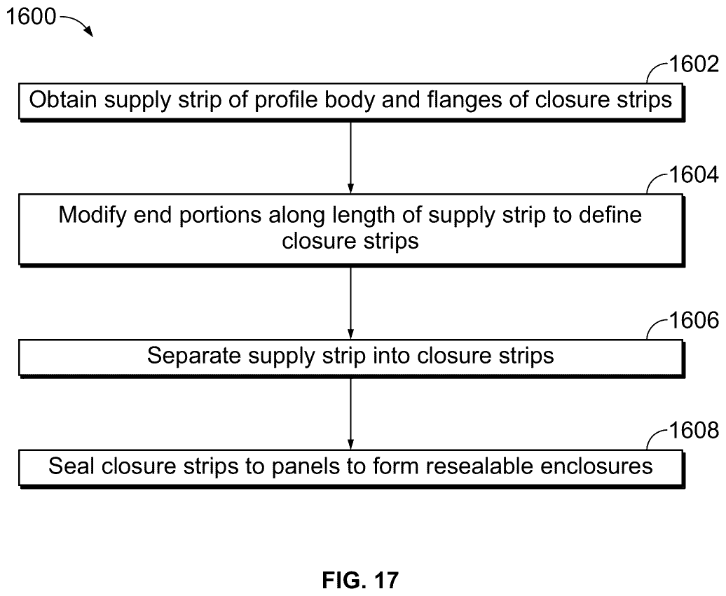

FIG. 17 illustrates a flowchart of one example of a method 1600 for forming termination ends of closure strips for resealable enclosures. The method 1600 can be used to modify the ends of a closure strip that are sealed between panels of a resealable enclosure (with the remainder of the closure strip extending along the panel(s) along the interior of the opening into the enclosure). The ends of the closure strip can be modified to provide improved seals (seals with little to no gaps) between the closure strip and the panels of the resealable enclosure.

At 1602, a supply strip of a profile body and flanges that form several closure strips is obtained. This supply strip can be extruded or otherwise formed to include opposing flanges with opposing profile bodies that engage each other, as described herein. At 1604, end portions of closure strips to be formed from the supply strip are modified. For example, different segments of the supply strip can be modified to define ends of closure strips. As described above in connection with FIGS. 5 and 6, one way to modify the supply strip is to remove portions of the flanges to define gaps in the flanges while the profile bodies are left to extend through and across the gaps. As described above in connection with FIGS. 7 and 8, another way to modify the supply strip is to remove portions of the profile body (and the flange located beneath the profile body) to define gaps in the profile body and flanges while the portions of the flange that remain extend around the gaps. As described above in connection with FIGS. 9 and 10, another way to modify the supply strip is to flatten portions of the profile body and/or the flange to define flattened portions along the length of the supply strip. As described above in connection with FIGS. 11 and 12, another way to modify the supply strip is to remove portions of the profile body (and not the flange located beneath the profile body) to define gaps in the profile body.

At 1606, the supply strip is separated into closure strips. For example, the supply strip can be cut in the gaps or the flattened portions described above. This separation can form several closure strips having the gaps or flattened portions at the opposite ends of the closure strips. At 1608, the closure strips are sealed to the panels to form a resealable closure into the enclosure. For example, seal bars may be used to apply heat and pressure to opposite sides of the panels with the closure strip located between the panels, as described above. The seal bars may include recessed grooves as described herein, or may not include the grooves. Optionally, the closure strips may not have modified ends and one or more seal bars having a grooved recess may be used to seal the closure strip(s) to the panels, as described above.

Various embodiments described herein can use a crushing force, heat, sealing, etc. to form various closure strips, ends of closure strips, to couple flanges to other bodies, and the like. Additionally, ultrasonic energy can be used to form the closure strips, the ends of the closure strips, to couple the flanges to other bodies, etc.

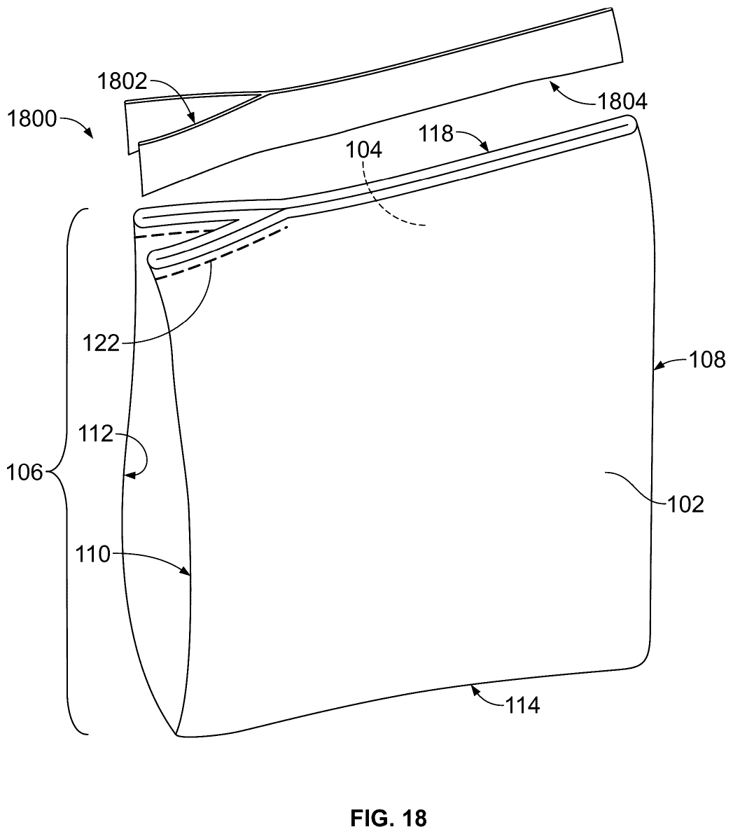

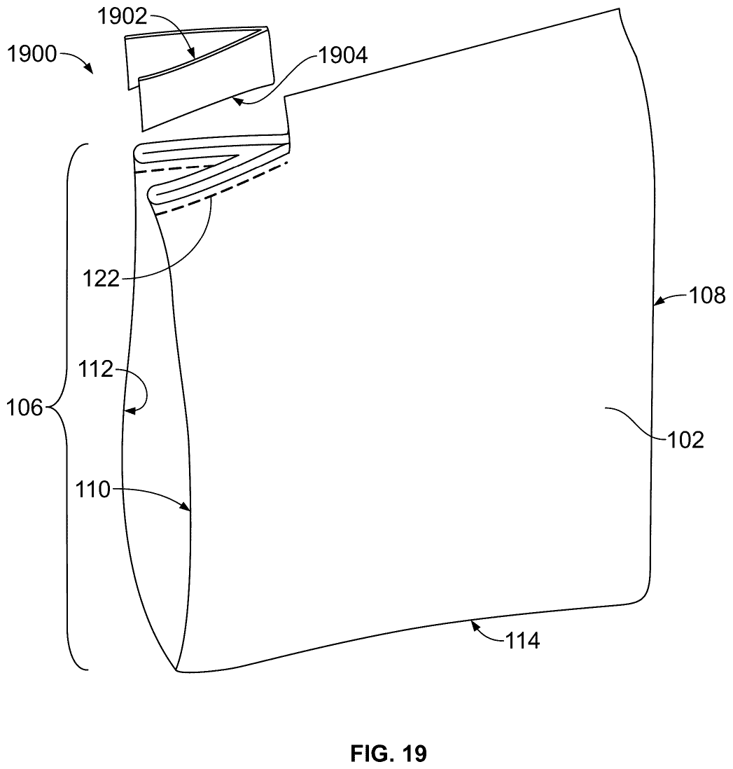

One or more embodiments of the enclosures described herein may include sealed, removable headers above the openings of the enclosures. FIGS. 18 and 19 illustrate examples of enclosures 1800, 1900 with such headers 1802, 1902. The headers 1802, 1902 can be portions of the panels 102, 104 of the enclosures 1800, 1900 that extend above the closure strips 122, 1700 and the top edge 118 of the enclosures 1800, 1900. These headers 1802, 1902 can enclose the top edge 118 and closure strips 122, 1700 until a consumer removes the headers 1802, 1902 to access the top edge 118 and closure strips 122, 1700. For example, perforations or other lines of weakness 1804, 1904 may be formed to define the location and size of the header 1802, 1902. The consumer can tear or otherwise remove the header 1802, 1902 along the perforations or lines of weakness 1804, 1904.

In one embodiment, a method is provided that includes obtaining an elongated supply strip formed from an elongated profile body and an elongated flange and modifying portions of the profile body, the flange, or a combination of the profile body and the flange in multiple different locations along a length of the supply strip. The portions are modified to define termination ends of closure strips. The method also includes separating the supply strip into at least one of the closure strips at the termination ends, coupling the flange in the at least one of the closure strips to one or more panels of a resealable enclosure, and partially sealing the panels of the resealable enclosure to each other to define an opening into the resealable enclosure. The profile body is configured to repeatedly couple with and decouple from itself to close and open the opening in the resealable enclosure. The panels are sealed to each other such that the ends of the closure strip are sealed between the panels.

Optionally, modifying the portions of the profile body, the flange, or the combination of the profile body and the flange of the supply strip can include removing segments of the flange to define gaps in the flange with the profile body continuously extending along the length of the supply strip and through the gaps.

Optionally, separating the supply strip into the at least one of the closure strips can include cutting through the profile body inside the gaps such that the ends of the closure strips include the profile body extending beyond the flanges.

Optionally, the panels can be sealed to each other such that the profile body that extends beyond the flanges is sealed to the panels in a sealed area between the panels with the flange outside of the sealed area between the panels.

Optionally, modifying the portions of the profile body, the flange, or the combination of the profile body and the flange of the supply strip can include removing segments of the combination of the profile body and the flange to define gaps in the profile body with the flange continuously extending outside of the gaps on opposite sides of the gaps along the length of the supply strip.

Optionally, separating the supply strip into the at least one of the closure strips can include cutting through the flange inside the gaps such that the ends of the closure strips include the flange extending beyond the profile body.

Optionally, the panels are sealed to each other such that the flange that extends beyond the profile body is sealed to the panels in a sealed area between the panels with a remainder of the flange located outside of the sealed area between the panels.

Optionally, modifying the portions of the profile body, the flange, or the combination of the profile body and the flange of the supply strip can include flattening segments of the profile body to define flattened portions in the profile body.

Optionally, separating the supply strip into the at least one of the closure strips can include cutting through the flattened portions.

Optionally, the panels can be sealed to each other such that the flattened portions are sealed to the panels in a sealed area between the panels with a remainder of the closure strip located outside of the sealed area between the panels.

Optionally, modifying the portions of the profile body, the flange, or the combination of the profile body and the flange of the supply strip can include removing segments of the profile body without removing any part of the flange to define gaps in the profile body with the flange continuously extending outside of the gaps on opposite sides of the gaps along the length of the supply strip.

Optionally, separating the supply strip into the at least one of the closure strips can include cutting through the flange inside the gaps such that the ends of the closure strips include the flange extending beyond the profile body.

Optionally, the panels can be sealed to each other such that the flange that extends beyond the profile body is sealed to the panels in a sealed area between the panels with a remainder of the flange located outside of the sealed area between the panels.

In one embodiment, another method is provided that includes obtaining a closure strip formed from an elongated profile body and an elongated flange. The profile body is configured to repeatedly couple with and decouple from itself. The method also includes placing the closure strip between panels of a resealable enclosure having an opening and placing seal bars on opposite sides of the panels with the closure strip between the panels. At least one of the seal bars has a recessed groove in a surface that engages at least one of the panels. The method also includes applying heat and pressure to the panels and the closure strip to seal the closure strip to the panels. The closure strip is configured to repeatedly couple with and decouple from itself to close and open an opening in the resealable enclosure.

Optionally, the seal bars are placed such that the profile body is received into the recessed groove during application of the heat and the pressure.

Optionally, both of the seal bars include the recessed groove.

In one embodiment, another method is provided that includes obtaining an elongated supply strip formed from an elongated profile body and an elongated flange and removing or flattening portions of the profile body, the flange, or a combination of the profile body and the flange in multiple different locations along a length of the supply strip. The portions can be modified to define termination ends of closure strips. The method also includes separating the supply strip into at least one of the closure strips at the termination ends, coupling the flange in the at least one of the closure strips to one or more panels of a resealable enclosure, and partially sealing the panels of the resealable enclosure to each other to define an opening into the resealable enclosure. The profile body is configured to repeatedly couple with and decouple from itself to close and open the opening in the resealable enclosure. The panels are sealed to each other such that the ends of the closure strip are sealed between the panels.

Optionally, removing or flattening the portions of the profile body, the flange, or the combination of the profile body and the flange of the supply strip includes removing segments of the flange to define gaps in the flange with the profile body continuously extending along the length of the supply strip and through the gaps.

Optionally, removing or flattening the portions of the profile body, the flange, or the combination of the profile body and the flange of the supply strip includes removing segments of the combination of the profile body and the flange to define gaps in the profile body with the flange continuously extending outside of the gaps on opposite sides of the gaps along the length of the supply strip.

Optionally, removing or flattening the portions of the profile body, the flange, or the combination of the profile body and the flange of the supply strip includes flattening segments of the profile body to define flattened portions in the profile body.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

1-13. (canceled)

14. A method comprising:
obtaining a closure strip formed from opposing elongated profile bodies and opposing elongated flanges, the profile bodies configured to repeatedly couple with and decouple from each other;
placing the closure strip between panels of a resealable enclosure having an opening;
placing seal bars on opposite sides of the panels with the closure strip between the panels, at least one of the seal bars having a recessed groove in a surface that engages at least one of the panels; and
applying heat and pressure to the panels and the closure strip to seal the closure strip to the panels, the closure strip configured to repeatedly couple with and decouple from itself to close and open an opening in the resealable enclosure.

15. The method of claim 14, wherein the seal bars are placed such that the profile bodies are received into the recessed groove during application of the heat and the pressure.

16. The method of claim 14, wherein each of the seal bars includes the recessed groove.

17-20. (canceled)

21. The method of claim 16, wherein the profile bodies are positioned between the recessed grooves of the seal bars.

22. The method of claim 14, wherein the recessed groove prevents crushing or flattening of the profile bodies during application of the heat and the pressure.

23. The method of claim 14, wherein the seal bars melt or bond the panels with the flanges around the profile bodies.

24. The method of claim 14, wherein the seal bars include a first seal bar and a second seal bar, the first seal bar having the recessed groove, the second seal bar having a flat surface that faces the recessed groove.

25. The method of claim 14, wherein the closure strip is sealed to the panels without removing any part of the profile bodies or the flanges from the closure strip.

26. A seal bar assembly comprising:
a first seal bar having a first flat surface; and a second seal bar having a second flat surface, at least one of the first flat surface of the first seal bar or the second flat surface of the second seal bar having a recessed groove extending into the at least one of the first flat surface or the second flat surface, the first seal bar and the second seal bar configured to receive a closure strip and panels of a resealable enclosure between the first seal bar and the second seal bar, the first seal bar and the second seal bar configured to receive the closure strip with elongated profile bodies and flanges of the closure strip between the first seal bar and the second seal bar, the first seal bar and the second seal bar configured to apply heat and pressure to the panels and the closure strip to seal the closure strip to the panels.

27. The seal bar assembly of claim 26, wherein the first seal bar and the second seal bar are positioned such that the profile bodies are received into the recessed groove during application of the heat and the pressure.

28. The seal bar assembly of claim 26, wherein each of the first seal bar and the second seal bar includes the recessed groove.

29. The seal bar assembly of claim 28, wherein the first seal bar and the second seal bar are configured to receive the profile bodies between the recessed grooves of the first seal bar and the second seal bar.

30. The seal bar assembly of claim 26, wherein the recessed groove prevents crushing or flattening of the profile bodies during application of the heat and the pressure.

31. The seal bar assembly of claim 26, wherein the first seal bar and the second seal bar are configured to melt or bond the panels with the flanges around the profile bodies.

32. The seal bar assembly of claim 26, wherein the first seal bar includes the recessed groove, but the second seal bar does not include the recessed groove.

33. The seal bar assembly of claim 26, wherein the first seal bar and the second seal bar are configured to seal the closure strip to the panels without removing any part of the profile bodies or the flanges from the closure strip.

34. A seal bar assembly comprising:
a first seal bar having a first flat surface with a first recessed groove extending into the first flat surface; and
a second seal bar having a second flat surface with a second recessed groove extending into the second flat surface, the first recessed groove and the second recessed groove opposing each other, the first seal bar and the second seal bar configured to receive a closure strip and panels of a resealable enclosure between the first seal bar and the second seal bar with profile bodies of the closure strip between the first recessed groove and the second recessed groove and flanges of the closure strip between the first flat surface and the second flat surface, the first seal bar and the second seal bar configured to apply heat and pressure to the panels and the closure strip to seal the flanges of the closure strip to the panels.

35. The seal bar assembly of claim 34, wherein the first seal bar with the first recessed groove and the second seal bar with the second recessed groove prevent crushing or flattening of the profile bodies during application of the heat and the pressure.

36. The seal bar assembly of claim 34, wherein the first seal bar and the second seal bar are configured to melt or bond the panels with the flanges around the profile bodies.

37. The seal bar assembly of claim 34, wherein the first seal bar and the second seal bar are configured to seal the closure strip to the panels without removing any part of the profile bodies or the flanges from the closure strip.
